(19) United States
(12) Patent Application Publication
(10) Pub. No.: US 2012/0272135 A1
(43) Pub. Date: Oct. 25, 2012

(54) METHODS AND SYSTEM FOR AUTOMATICALLY CREATING OF LARGE NUMBER OF WEBSITES FOR COMMUNICATION, MEDIA SHARING, AND MANAGEMENT WITHIN GROUPS

(76) Inventors: Roland K. Wiley, Burlingame, CA (US); Benjamin C. Guthrie, Sunnyvale, CA (US); Peter J. Gremett, Sunnyvale, CA (US); Marco Santini, El Sobrante, CA (US)

(21) Appl. No.: 13/443,193

(22) Filed: Apr. 10, 2012

Related U.S. Application Data
(60) Provisional application No. 61/478,294, filed on Apr. 22, 2011.

(51) Int. Cl. G06F 17/00; G06F 15/16

(52) U.S. Cl. 715/234

(57) ABSTRACT

A computer-implemented method is disclosed for creating a plurality of group websites for a plurality of groups in a club or a league. The method includes receiving, by a computer network system, group data for a plurality of groups in a club or a league, wherein the group data include names for the groups, names and email addresses for managers of the groups, and at least one member's name for each of the plurality of teams; creating, by the computer network system, data structures for a plurality of group websites using the group data; automatically assigning web addresses to the group websites by the computer network system, wherein the plurality of group websites are activated for the plurality of groups in the club or the league; and allowing the managers of the groups to edit the plurality of group websites for their respective groups.

### CROSS-REFERENCES TO RELATED APPLICATIONS

The present application claims priority to pending U.S. provisional patent application 61/478,294, titled “Methods and system for automatically creating of large number of websites for communication, media sharing, and management within groups”, filed by the same inventors on Apr. 22, 2011, the content of which is incorporated herein by reference.

### BACKGROUND OF THE INVENTION

The creation of a group website is a rather manual, time consuming, and often error-prone process. A manager is required to first register and create a new group website. Information about the group and each member is manually entered. The manager then sends invitations to members to invite them to join the group website. Examples of groups include sports teams in a league, classes in a school, schools in a school district, divisions or business units in a company, or other groups in an institution, etc.

The amount of work is multiplied when a large number of group websites need to be created. The example below will focus on the creation of team websites for sports teams in a league, but the methods and system could be applied to other types of groups.

### SUMMARY OF THE INVENTION

In one aspect, the present application relates to a computer-implemented method for creating a plurality of group websites for a plurality of groups in a club or a league. The method includes receiving, by a computer network system, group data for a plurality of groups in a club or a league, wherein the group data include names for the groups, names and email addresses for managers of the groups, and at least one member's name for each of the plurality of teams; creating, by the computer network system, data structures for a plurality of group websites using the group data; automatically assigning web addresses to the group websites by the computer network system, wherein the plurality of group websites are activated for the plurality of groups in the club or the league; and allowing the managers of the groups to edit the plurality of group websites for their respective groups.

In another aspect, the present application relates to a computer network system for creating a plurality of group websites for a plurality of groups in a club or a league, comprising a computer server configured to receive group data for a plurality of groups in a club or a league, wherein the group data include names for the groups, names and email addresses for managers of the groups, and at least one member's name for each of the plurality of teams. The computer network system also includes a group website creation engine in communication with the computer server and configured to create data structures for a plurality of group websites using the group data, to automatically assign web addresses to the group websites, and to allow the plurality of group websites to be activated for the plurality of groups in the club or the league, wherein the computer server is configured to allow the group managers to edit the plurality of group websites for their respective groups.

Implementations of the system may include one or more of the following. The group website creation engine can simultaneously create the data structures for the plurality of group websites in a batch operation. The group website creation engine can create the data structures for the plurality of group websites in response to a command by an administrator of the league or club. The group website creation engine can allow one of the managers to activate one of the plurality of group websites associated with the group managed by the one of the managers. The server can notify the group managers about the creations of the plurality of group websites to allow the managers to activate edit their respective group websites. The group data can further include an email address of at least one member's name for each of the plurality of teams, wherein the email address is incorporated into one of the data structures for the plurality of group websites. The group website creation engine can automatically check errors in the group data and to allow an administrator of the league or club to correct the errors. The group website creation engine can receive information about the club or league from an administrator of the league or club and to incorporate the information about the club or league into the data structure for the plurality of group websites. The league can include a youth sports club comprising a plurality of teams, wherein the group data comprise team names, team division, team age, coaches' names for the plurality of teams, players' names, player's genders, players' jersey numbers, or players' parents names and contact information in each of the plurality of teams. The group data can be received in a data file in a format selected from the group consisting of Excel, CSV, or JSON.

Embodiments may include one or more of the following advantages. The disclosed system and methods for creating is scalable to an organization comprising a large number of groups, including multi-level organizations. The disclosed system and methods provide a way to create a large number of group sites in a simple process. The disclosed system and methods significantly reduce time and effort for creating a large number of group sites for organizations such as clubs and sports leagues that have the needs for creating multiple group sites.

The disclosed system and methods provide accuracy and consistency in creating a large number of group sites. Error checking ensures that accurate information is automatically populated on the group sites. The disclosed system and methods provide comprehensive and flexible management tool for the club manager, and flexible design tools for team managers for group site designs and permission for different roles.

### BRIEF DESCRIPTION OF THE DRAWINGS

FIG. 1A is a block diagram for a group website management system in accordance to the present invention.

FIG. 1B is a flowchart for creating a large number of group websites in a group in accordance to the present invention.

FIGS. 2-3 show a management user interface for an administrator to enter information about a sport league.

FIG. 4 shows a management user interface for importing data for all the teams in the sport league in preparation for creating group websites for the teams in the sport league.

FIG. 5-6 show a management user interface for automatically checking errors and confirming imported data for the teams in the sport league in preparation for group website creation for all the teams.

FIG. 7 shows a management user interface for a league administrator to review and submit the creation of all the teams in the sport league.

FIG. 8 shows a landing web page for a team manager to sign in or sign up the newly created team group website in the sport league.

FIG. 9 shows a user interface showing automatically created web address for the team group website.

FIGS. 10-13 show a management user interface for a team manager to review, verify, enter, select, and create designs or content for a sport team group website.

FIG. 14 shows a user interface for the team manager to share the team group website to team members.

FIG. 15 shows an exemplified sport team group website in accordance to the present invention.

Although the invention has been particularly shown and described with reference to multiple embodiments, it will be understood by persons skilled in the relevant art that various changes in form and details can be made therein without departing from the spirit and scope of the invention.

### DETAILED DESCRIPTION OF THE INVENTION

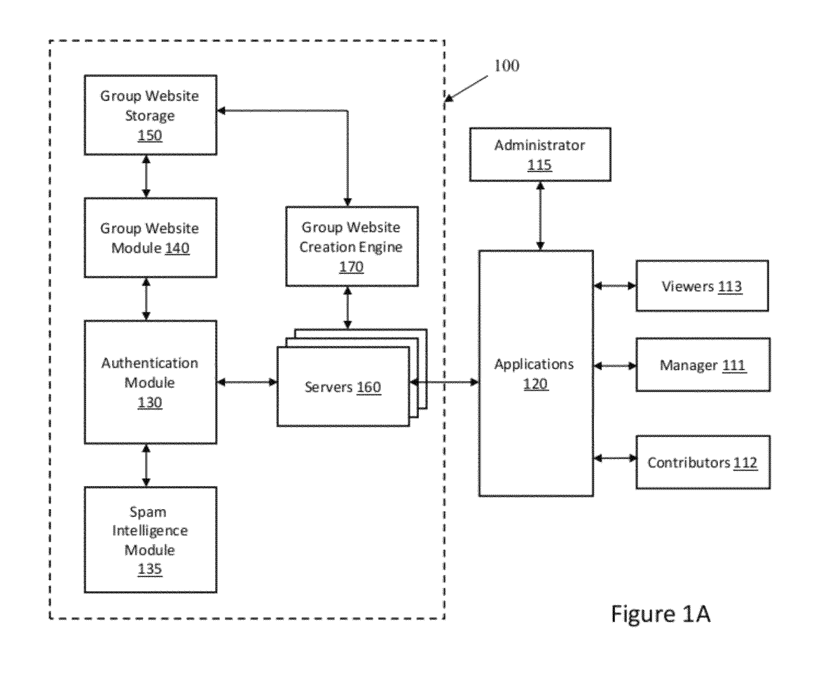

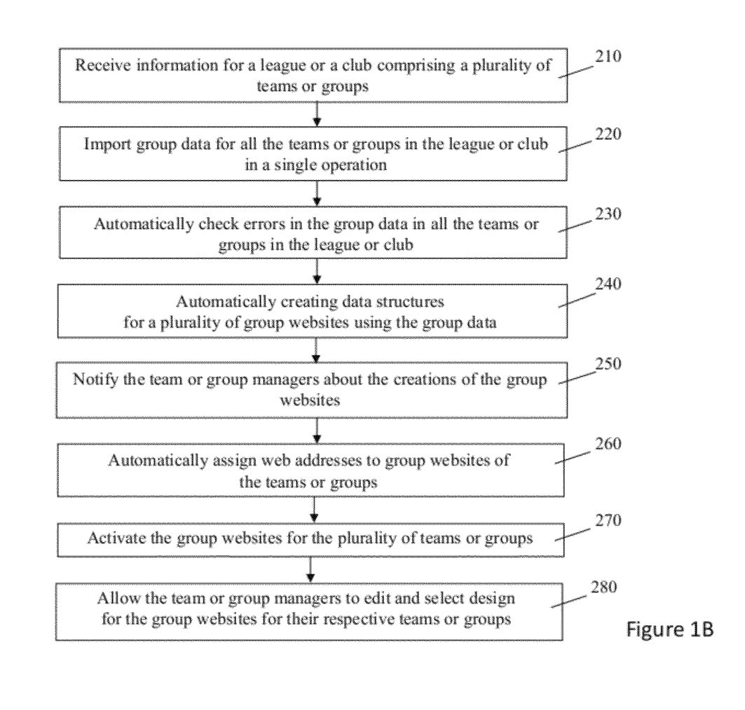

A network-based computer system 100, as shown in FIG. 1A, communicates with users such as a manager 111, contributors 112, and viewers 113 via applications 120. The network-based computer system 100 includes an authentication module 130, a spam intelligence module 135, a group website module 140, group website storage 150, and servers 160 for communicating with applications 120 over a computer network. The authentication module 130 further includes an application authentication module 131, a user authentication module 132, and a user access-control module 133.

The users of the group websites can also include an administrator 115 of a league or a club that is responsible for setting up a large number of group websites for the teams or groups within the league or the club. An example for the manager 111 is a coach or a team parent for a sport team within the league.

The network-based computer system 100 includes a group website creation engine 170 that is configured to create a large number of group websites in a single batch operation using group data for the teams or groups in the league or club.

Users of the network-based computer system 100 can have different roles such as manager 111 who is the owner and administrator of the group website, contributors 112, and viewers 113. Users communicate with the network-based computer system 100 via applications 120 which can publish content at the group website from network-based computer system 100 on users' display devices. Examples of content at the web site include text, images, videos, and designs. The applications 120 can be implemented in different forms and on different platforms, including but not limited to, web browser and device applications 123 installed on devices such as smart phones, tablet computers, etc. which allow users to access the group websites. Applications 120 can also include electronic message application 121 such as Yahoo mail, gmail, hotmail etc., short messages (SMS), and texting, etc. for the viewers 113 to receive messages from the group website manager 111 about registration and updated content. In the present application, the term “email” is used to represent different forms of electronic messages.

A league of sports teams, such as a regional youth soccer league, usually have many teams (e.g. 25 or more) youth teams for each season. Before the start of a season, the administrator 115 of the league needs to create group websites for the teams to share photos and videos, manage team communications, coordinate volunteers, and schedule team activities.

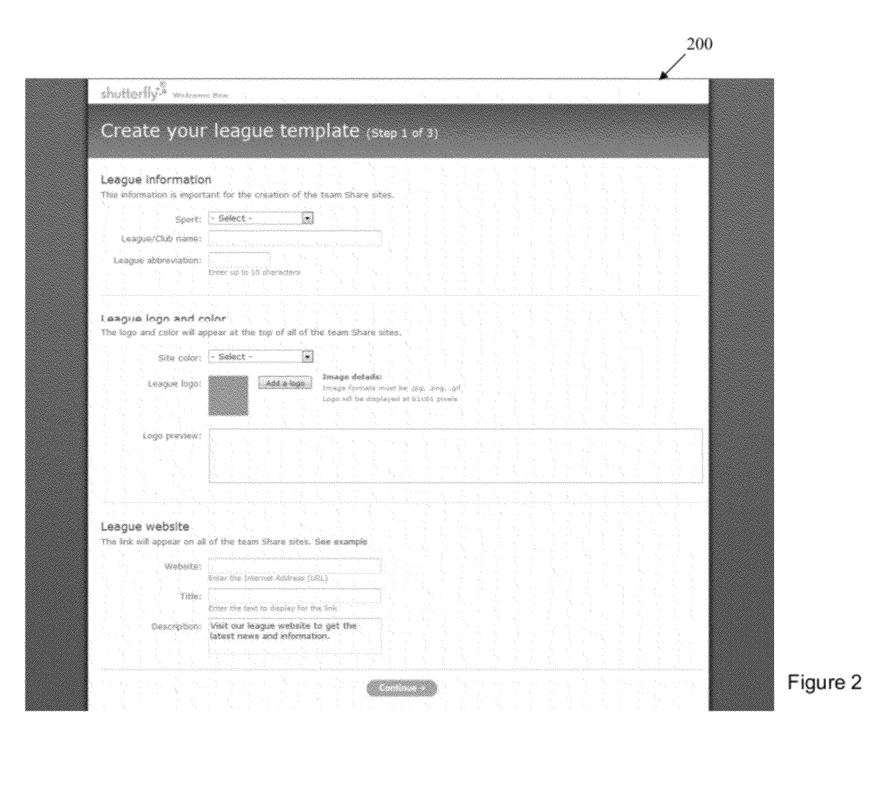

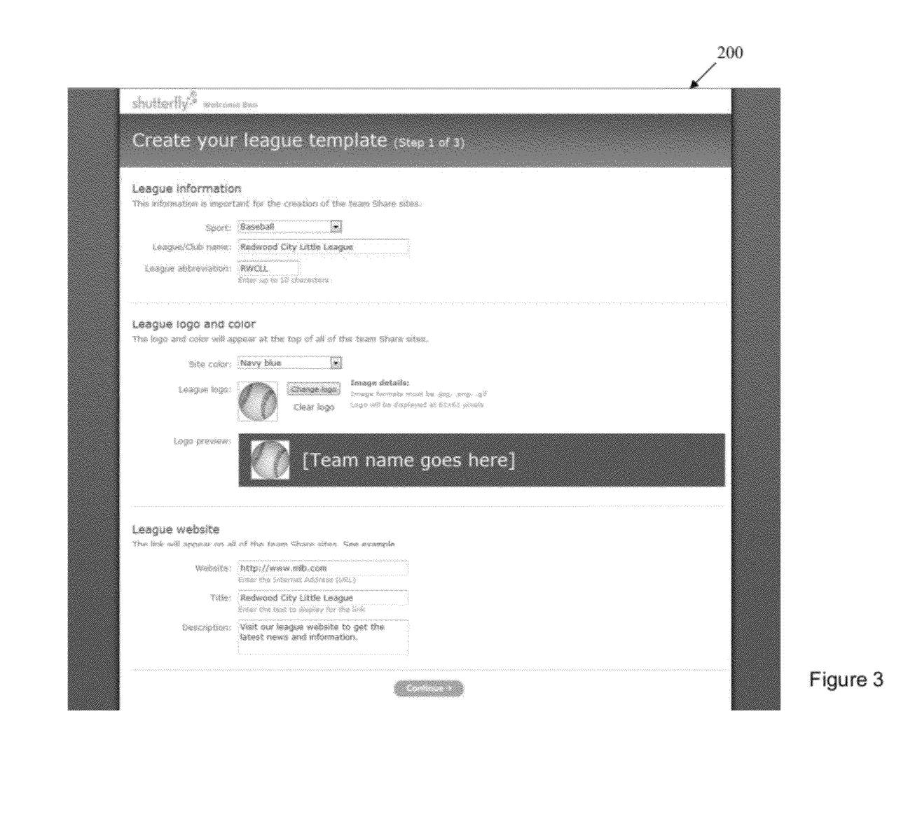

Referring to FIG. 1B, the group websites creation engine 170 in the network-based computer system 100 (FIG. 1A) allows the league administrator 115 to create a large number of team group websites in a batch operation. The group websites creation engine 170 (FIG. 1A) enables to display a template at user interface 300, as shown in FIGS. 2-3, which allows the administrator 115 to select a sport type, enter the league name, upload a league logo, and input the league website address (step 210, FIG. 1B).

The template structure for the league or club allows the methods described in the present application to be scalable to a plurality of leagues or clubs. For example, a national youth soccer organization includes many regional leagues each of which in turn comprises many teams. The disclosed methods and system can be applied to effective group websites creation for multi-level organizations.

The information for the whole club or league is to be embedded by the group websites creation engine 170 in the data structures of the group sites for the groups or teams within the league or club. For example, the abbreviation for the league's name can be “RECLL”. The group websites within the league can all include the league's name or its “RECLL”.

Information about the teams in the league, also referred as group data, is stored in a data file or may be exported from a league database into a data file. The data file can be in the format of Excel, CSV, or JSON. The data may include standard fields such as: PlayerFirstName, PlayerLastName, PlayerGender, PlayerAddress . . . JerseyNumber, School, ParentGuardian1FirstName, ParentGuardian1LastName, ParentGuardian1Email, ParentGuardian1Phone . . . TeamId, TeamName, TeamDivision, TeamGender, CoachFirstName, CoachLastName, CoachEmail, CoachHomePhone, CoachCellPhone, CoachWorkPhone, AsstCoachFirstName, AsstCoachLastName, AsstCoachEmail . . . TeamParentFirstName, TeamParentLastName, TeamParentEmail . . . , etc. Since the league usually already has all of the above described information, the data file can be easily created by simply formatting existing data.

The data file can be submitted by the administrator 115 (FIG. 1) to the servers 160 and then to the group websites creation engine 170. The group data can also be retrieved from database for the sport league such as the group websites storage 150 (FIG. 1).

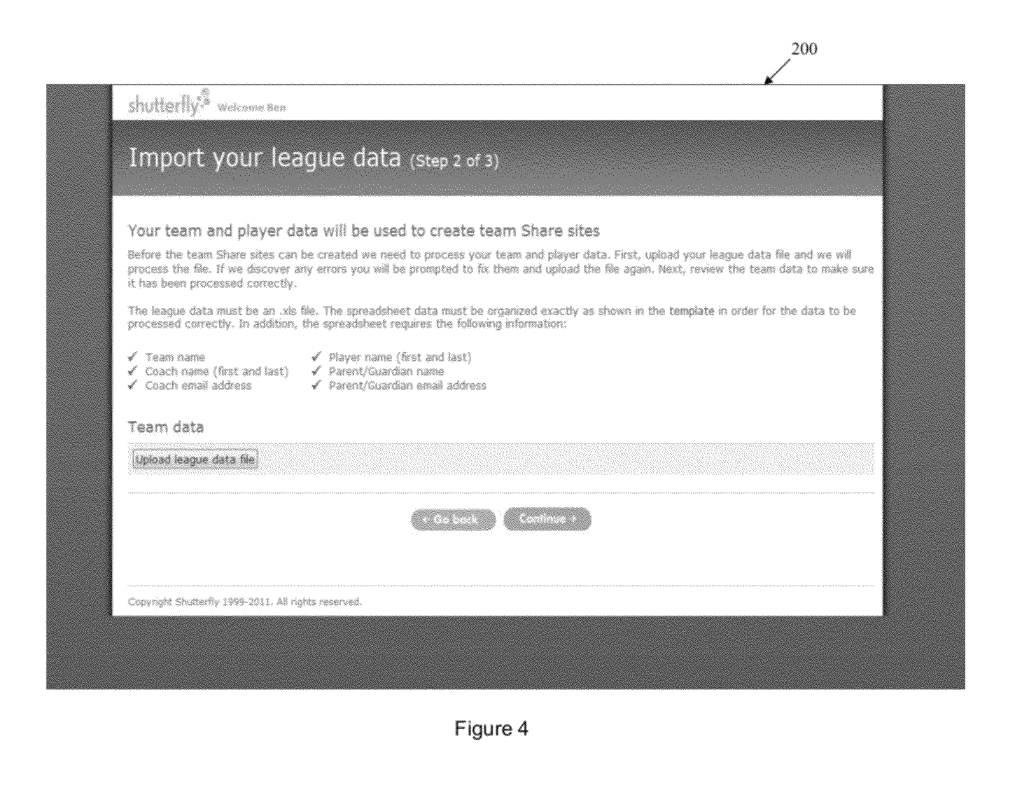

The creation of team websites only requires a minimum amount of information for each team, such as team name, the coach's (i.e. the group manager's) name and email address, at least one player per team, and the players' parent name and email address (FIG. 4).

The group data for all the teams in the league are imported to the group websites creation engine 170 as a group in a single batch operation (step 220, FIG. 1B). The servers 160 (FIG. 1A) enables the uploaded data to be displayed and viewable by the administrator in a format consistent with the data file. An advantage of the presently disclosed methods and system is that it drastically reduces the time and effort for creating a large number of group websites: many group websites can be created in a batch instead of separately. The chances for errors are also significantly decreased.

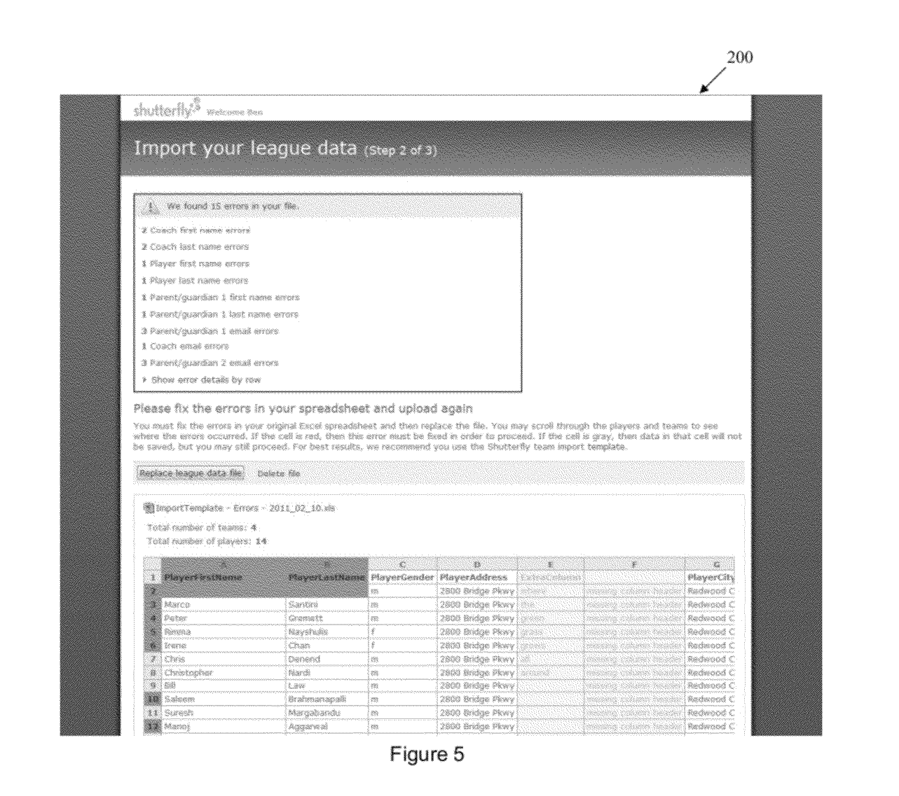

The group websites creation engine 170 (FIG. 1A) automatically checks errors in the group data (step 230, FIG. 1B). If such errors exist, the servers 160 enable to display an alert message on the administrator 115's device about where errors exist in the data file. The administrator 115 can input missing data and make corrections (FIG. 5).

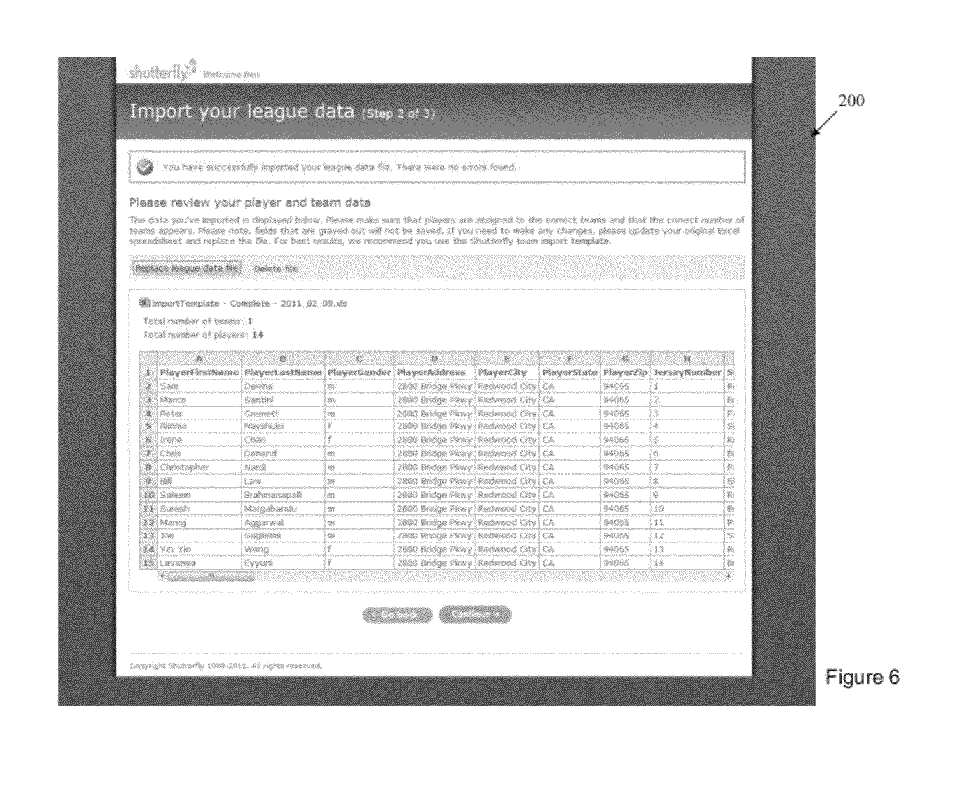

The servers 160 (FIG. 1A) provides a user interface for the administrator 115 to review each team's information (FIG. 6). After the information is corrected and uploaded, with a single click by the administrator 115, the data structures of a plurality of team websites are automatically created using the team name as the team website name and assigning the coaches and team parents as site owners or managers of each team website (step 240, FIG. 1B). The data about each team (i.e. team data or group data) is automatically used to populate the corresponding data fields for each team website (FIG. 6). For example, the names and contact information for the coach, assistant coach, team parent, and players' parents are automatically stored in the team website. Player names, jersey numbers, and other player information provided by the administrator 115 are used to populate each team's roster.

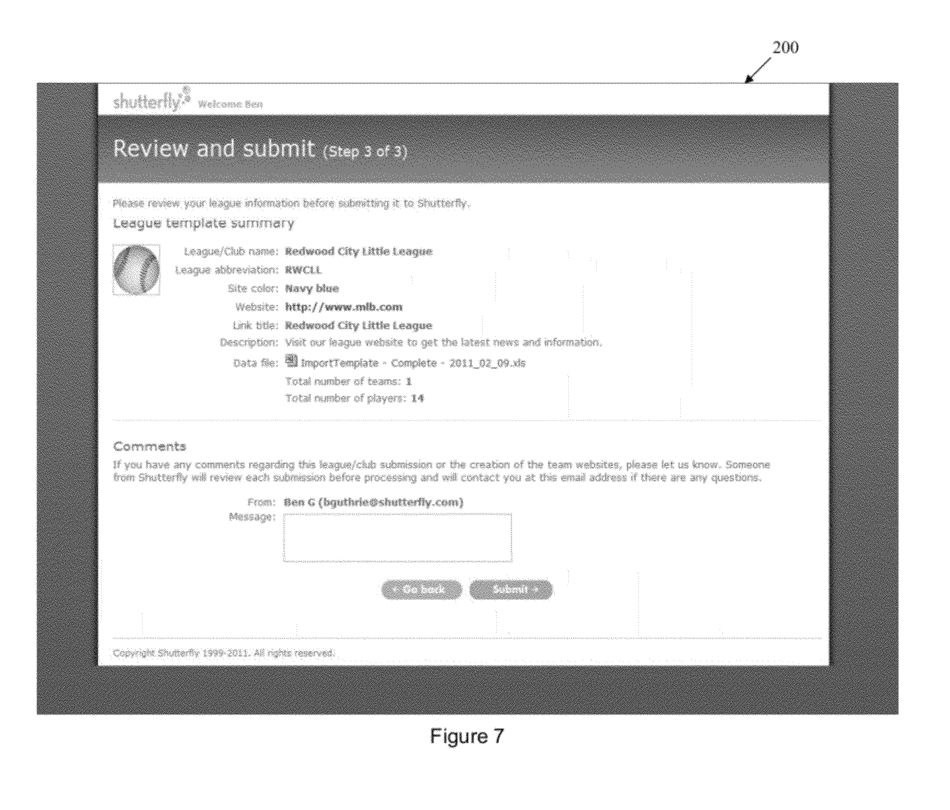

The administrator 115 finishes creating data structures for team websites in the league at a review and submit page (FIG. 7). The administrator 115 subsequently receives a confirmation message from the network-based computer system 100 (FIG. 1A).

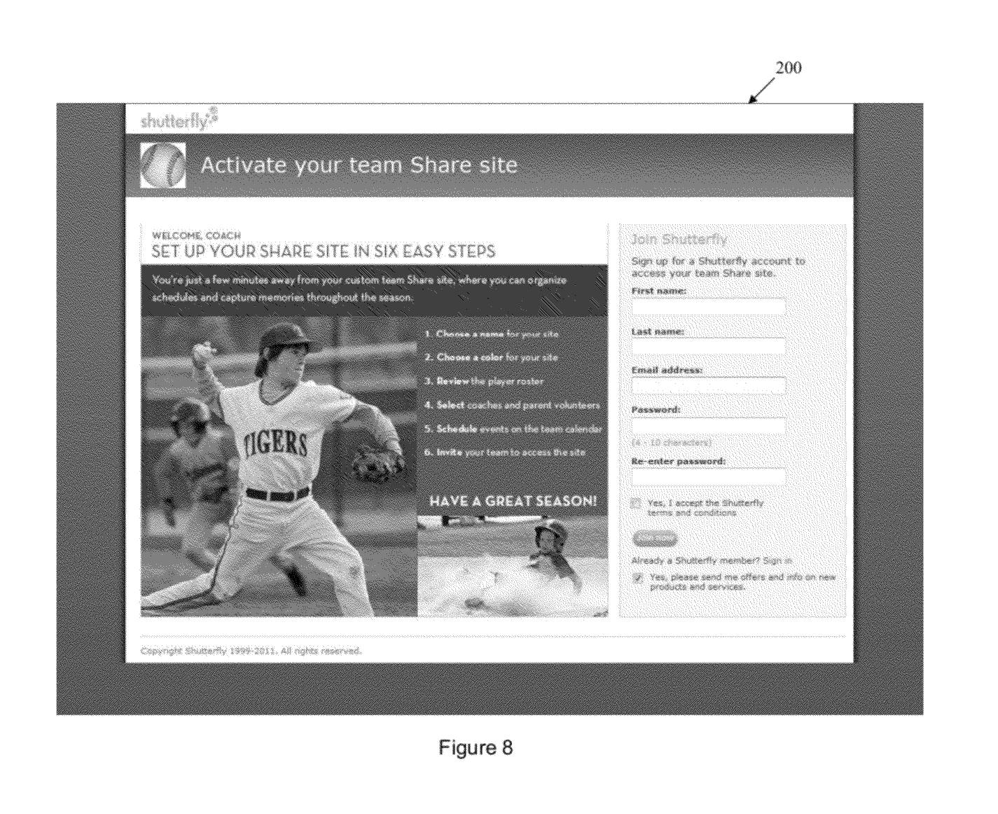

After the data structures of the team sites are created, each of the primary team managers (e.g. the coach or the team parent) receives an email from servers 160 (FIG. 1A) about that his/her team website is ready to be activated (step 250, FIG. 1B). The team manager or the coach can sign up or sign in to activate the website just created (FIG. 8).

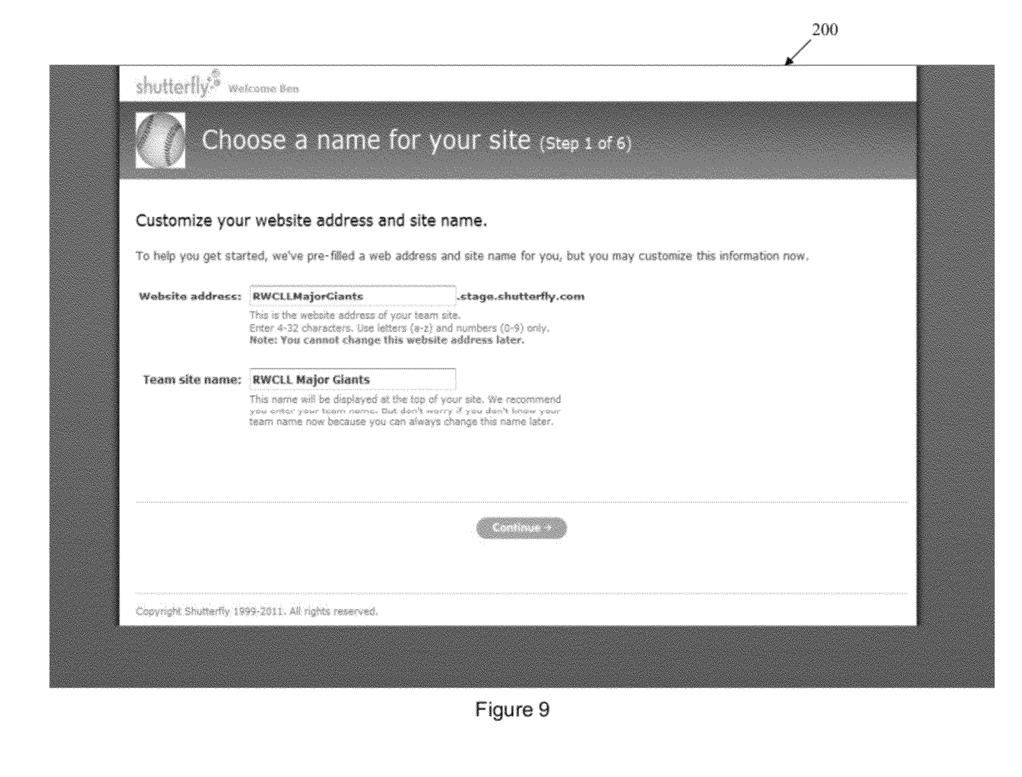

The team website can be automatically assigned a web address using a predefined convention such as “TEAMNAME.shutterfly.com” (step 260, FIG. 1B). The prefix of the team website URL may be modified by the website owner (FIG. 9). Once the URL is finalized, the team website is activated based on the data structure for the team site (step 270, FIG. 1B). The team website becomes accessible by authorized members of the group.

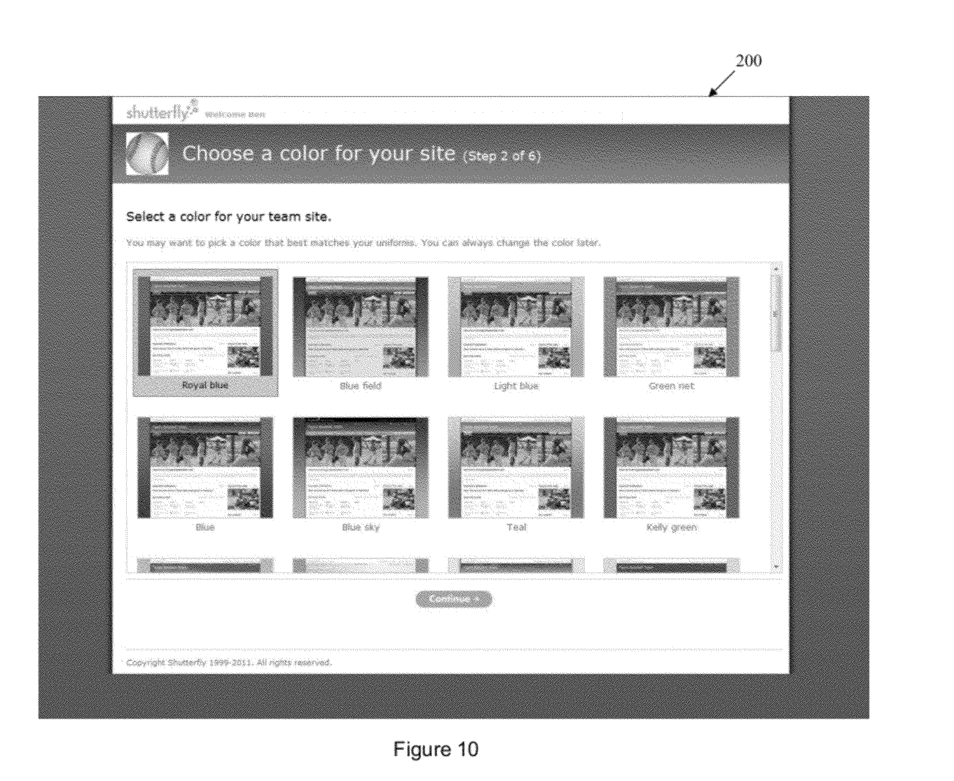

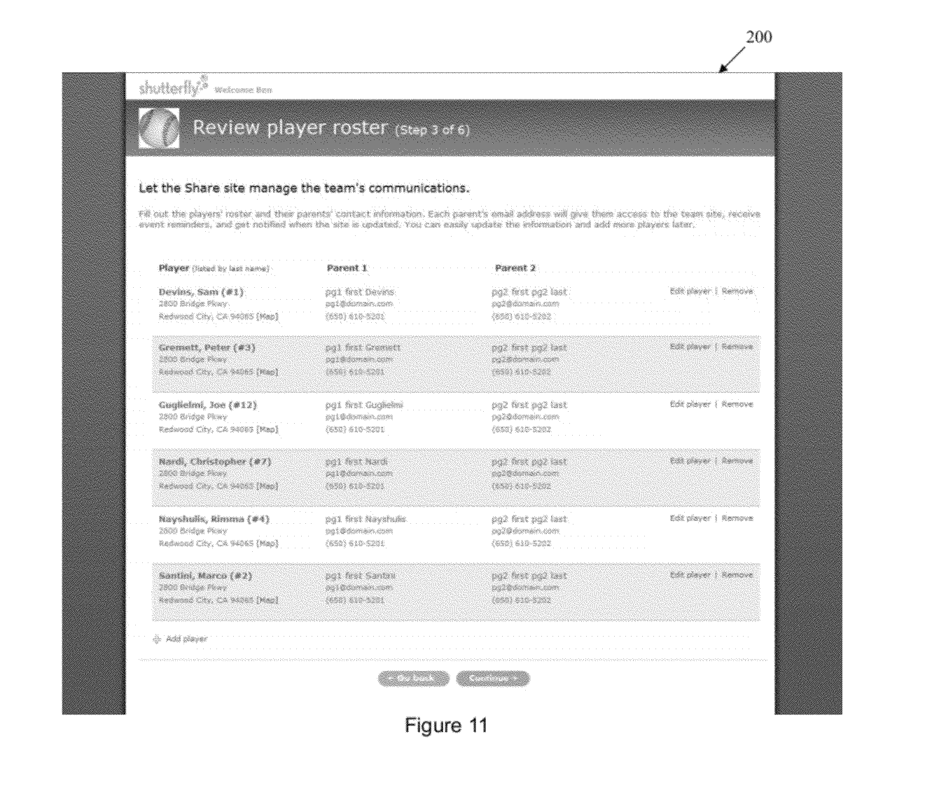

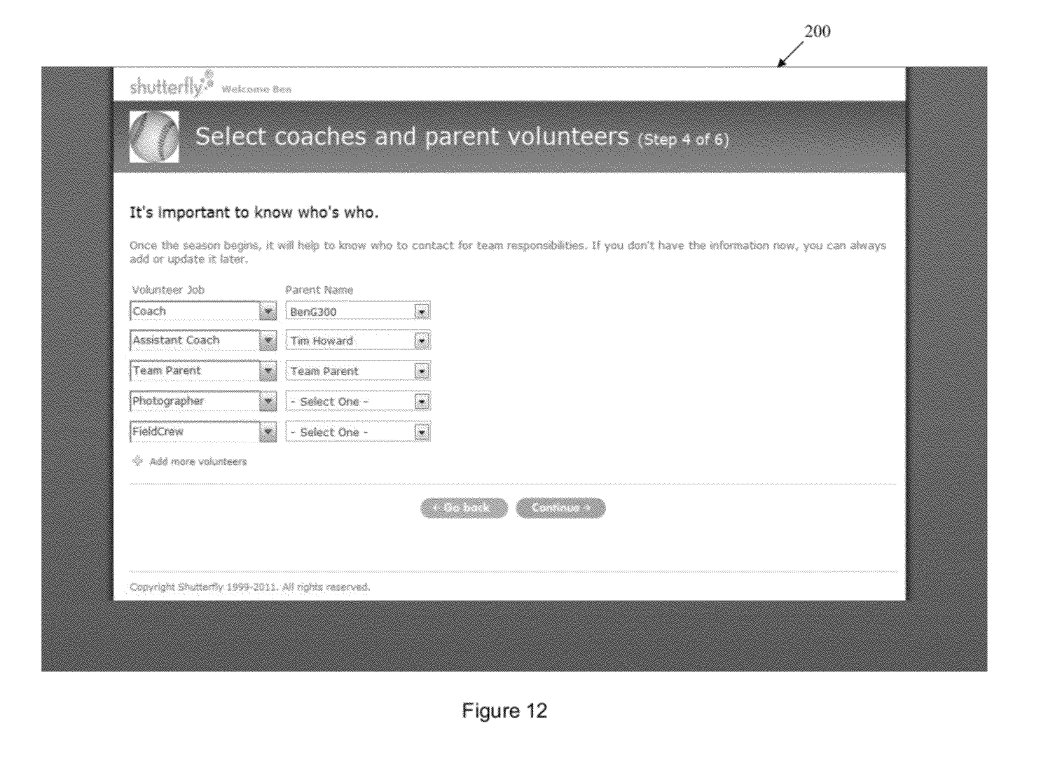

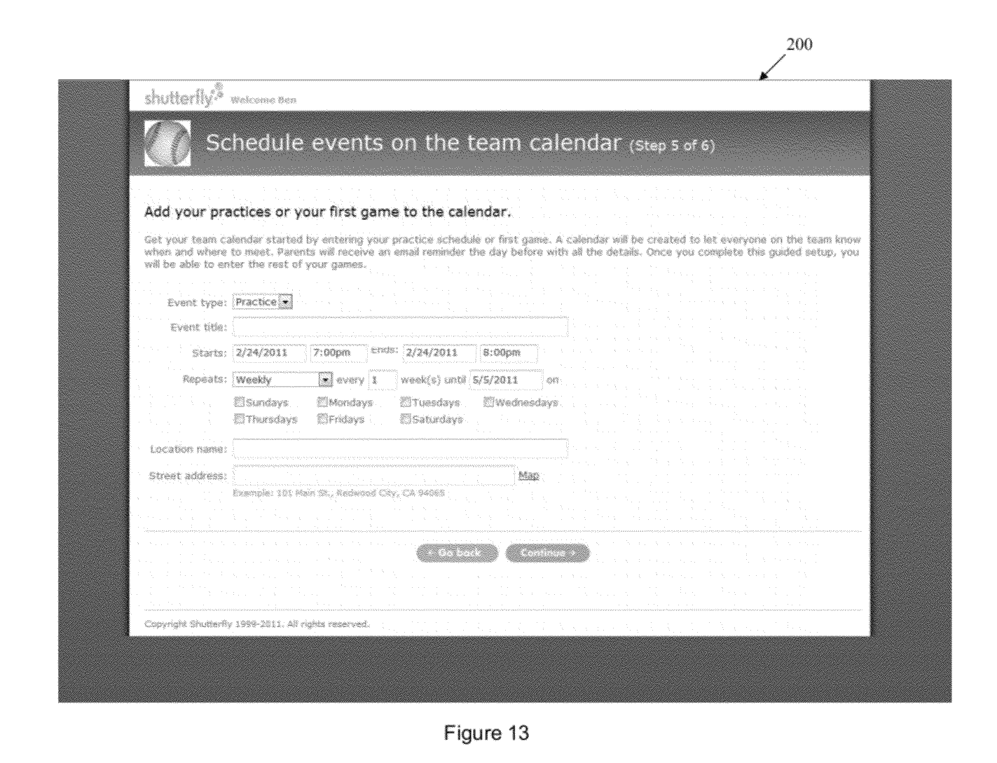

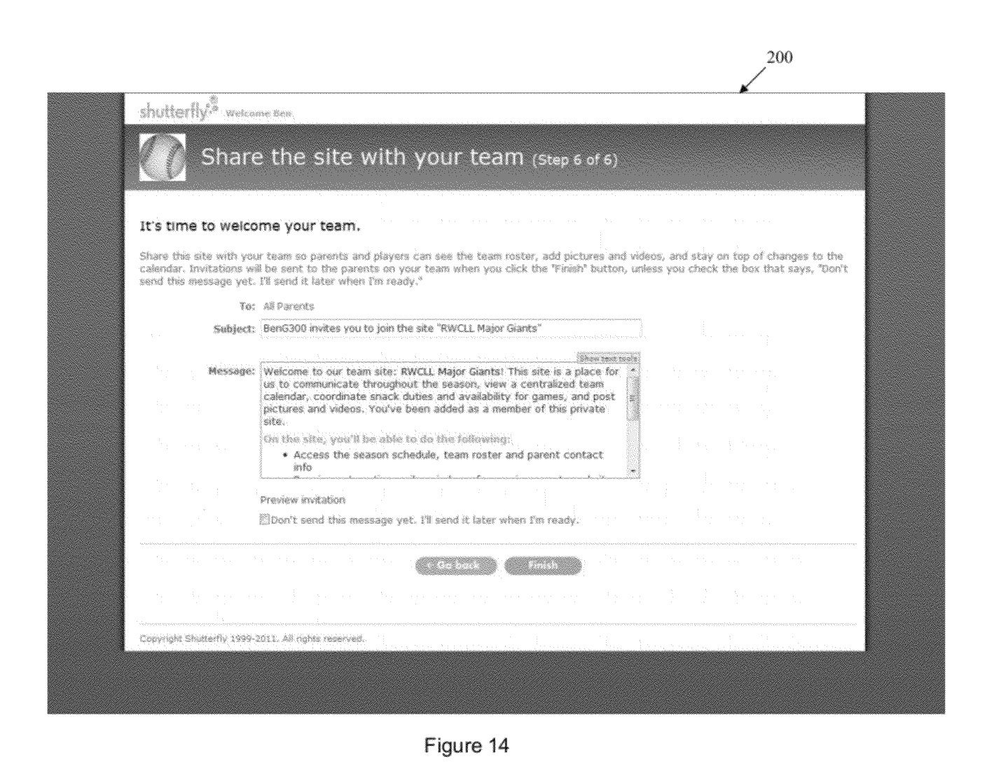

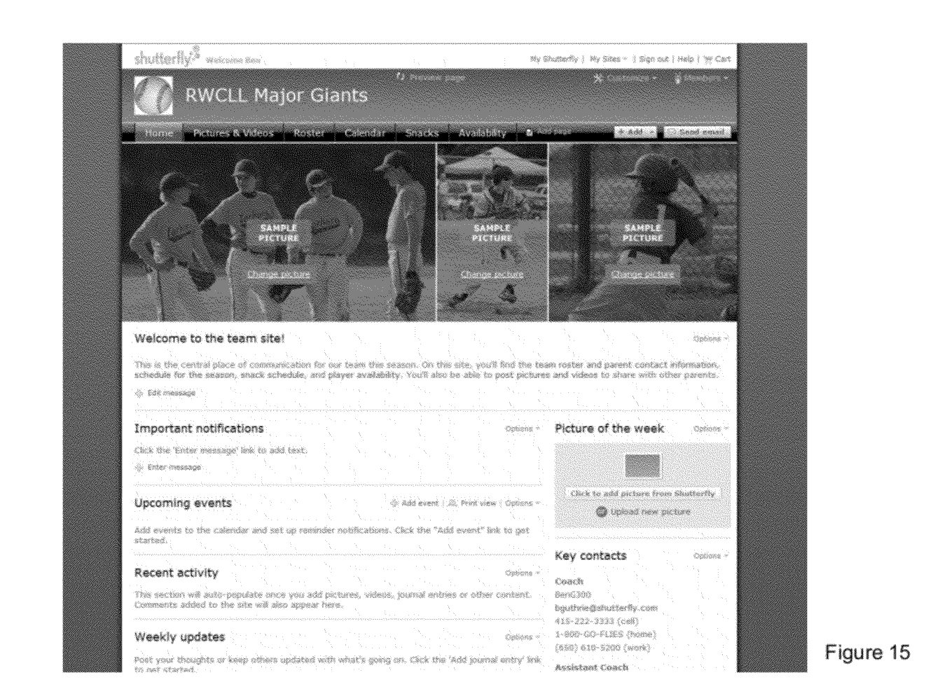

The team website owner or manager can edit and update information already uploaded, select designs and styles for his/her team website, and input team activities and schedules, etc. (step 280, FIG. 1B). For example, the team manager can select color for the steam group website (FIG. 10), review the player roster on the team (FIG. 11), select coaches and volunteers (FIG. 12), schedule events on the team calendar (FIG. 13), and share the group website with team (FIG. 14). After his or her review, the team manager receives a confirmation for the activation of the group website. Emails are sent to the team members and team parents to welcome them to the team group website. They can each visit the corresponding group website to select a password. An example of a team group website is shown in FIG. 15.

It should also be noted that the detailed configurations and steps can differ from the examples described above without deviating from the spirit of the present invention. For example, the modules and components in the network-based computer system can exist in different configurations. The user interface and web pages for achieving above described operations can exist in different designs from the examples illustrated above.

The orders of the above described steps can be altered without deviating from the spirit of the present invention. For example, the web addresses are often assigned to the group websites of the teams or groups before the managers of the teams or groups receive the notifications about the creations of the group websites.

What is claimed is:

1. A computer-implemented method for creating a plurality of group websites for a plurality of groups in a club or a league, comprising:
receiving, by a computer network system, group data for a plurality of groups in a club or a league, wherein the group data include names for the groups, names and email addresses for managers of the groups, and at least one member's name for each of the plurality of teams;
creating, by the computer network system, data structures for a plurality of group websites using the group data;
automatically assigning web addresses to the group websites by the computer network system, wherein the plurality of group websites are activated for the plurality of groups in the club or the league; and
allowing the managers of the groups to edit the plurality of group websites for their respective groups.

2. The computer-implemented method of claim 1, wherein the data structures for the plurality of group websites are simultaneously created in a batch operation by the computer network system.

3. The computer-implemented method of claim 2, wherein the data structures for the plurality of group websites are created in response to a command by an administrator of the league or club.

4. The computer-implemented method of claim 1, further comprising:
allowing one of the managers to activate one of the plurality of group websites associated with the group managed by the one of the managers.

5. The computer-implemented method of claim 4, further comprising:
notifying the group managers about the creations of the plurality of group websites to allow the managers to activate edit their respective group websites.

6. The computer-implemented method of claim 1, wherein the group data further include an email address of at least one member's name for each of the plurality of teams, wherein the email address is incorporated into one of the data structures for the plurality of group websites.

7. The computer-implemented method of claim 1, further comprising:
automatically checking errors in the group data; and
allowing an administrator of the league or club to correct the errors.

8. The computer-implemented method of claim 1, further comprising:
receiving information about the club or league from an administrator of the league or club; and
incorporating the information about the club or league into the data structure for the plurality of group websites by the group website creation engine.

9. The computer-implemented method of claim 1, wherein the league is a youth sports club comprising a plurality of teams, wherein the group data comprise team names, team division, team age, coaches' names for the plurality of teams, players' names, player's genders, players' jersey numbers, or players' parents names and contact information in each of the plurality of teams.

10. The computer-implemented method of claim 1, wherein the group data are received in a data file in a format selected from the group consisting of Excel, CSV, or JSON.

11. A computer network system for creating a plurality of group websites for a plurality of groups in a club or a league, comprising:
a computer server configured to receive group data for a plurality of groups in a club or a league, wherein the group data include names for the groups, names and email addresses for managers of the groups, and at least one member's name for each of the plurality of teams; and
a group website creation engine in communication with the computer server and configured to create data structures for a plurality of group websites using the group data, to automatically assign web addresses to the group websites, and to allow the plurality of group websites to be activated for the plurality of groups in the club or the league, wherein the computer server is configured to allow the group managers to edit the plurality of group websites for their respective groups.

12. The computer network system of claim 11, wherein the group website creation engine is configured to simultaneously create the data structures for the plurality of group websites in a batch operation.

13. The computer network system of claim 12, wherein the group website creation engine is configured to create the data structures for the plurality of group websites in response to a command by an administrator of the league or club.

14. The computer network system of claim 12, wherein the group website creation engine is configured to allow one of the managers to activate one of the plurality of group websites associated with the group managed by the one of the managers.

15. The computer network system of claim 14, wherein the server is configured to notify the group managers about the creations of the plurality of group websites to allow the managers to activate edit their respective group websites.

16. The computer network system of claim 11, wherein the group data further include an email address of at least one member's name for each of the plurality of teams, wherein the email address is incorporated into one of the data structures for the plurality of group websites.

17. The computer network system of claim 11, wherein the group website creation engine is configured to automatically check errors in the group data and to allow an administrator of the league or club to correct the errors.

18. The computer network system of claim 11, wherein the group website creation engine is configured to receive information about the club or league from an administrator of the league or club and to incorporate the information about the club or league into the data structure for the plurality of group websites.

19. The computer network system of claim 11, wherein the league is a youth sports club comprising a plurality of teams, wherein the group data comprise team names, team division, team age, coaches' names for the plurality of teams, players' names, player's genders, players' jersey numbers, or players' parents names and contact information in each of the plurality of teams.

20. The computer network system of claim 11, wherein the group data are received in a data file in a format selected from the group consisting of Excel, CSV, or JSON.
